(19) United States
(12) Patent Application Publication
(10) Pub. No.: US 2010/0094708 A1
(43) Pub. Date: Apr. 15, 2010

(54) INVENTORY IDENTIFIERS

(75) Inventors: Venkatesh B. Natrajan, Santa Clara, CA (US); Margaret Shih, Burbank, CA (US); David Chaiken, Santa Clara, CA (US); Dirk Reinshagen, Santa Clara, CA (US); Matt Plummer, Burbank, CA (US); Steven Hartman, Burbank, CA (US); Scott Shifflett, Burbank, CA (US); Raymie Stata, Santa Clara, CA (US)

Correspondence Address: MPG, LLP AND YAHOO! INC., 710 LAKEWAY DRIVE, SUITE 200, SUNNYVALE, CA, 94085, US

(73) Assignee: Yahoo! Inc., Sunnyvale, CA (US)

(21) Appl. No.: 12/252,325

(22) Filed: Oct. 15, 2008

(51) Int. Cl. G06Q 30/00; G06F 7/06; G06F 17/30

(52) U.S. Cl. 705/14.55; 707/E17.108; 705/14.73

(57) ABSTRACT

A system for defining objects within a database is disclosed. The system includes an inventory identification application that generates an inventory identifier. The inventory identifier being a reference saved to the database that specifies characteristics of data within an inventory unit. A publisher using the inventory identifier application defines the specific characteristics and the inventory identifier application generates code. The publishers use the generated code within a website to recall the inventory identifier that is saved in the database. The system also includes a server system that receives a request to recall the inventory identifier. The request is the result of execution of the generated code when the website is accessed by a user. The request is fulfilled by accessing the inventory identifier at the database and matching data within the inventory unit based on the stored characteristics within the inventory identifier.

### BACKGROUND

### Description of the Related Art

The computing industry has seen many advances in recent years, and such advances have produced a multitude of products and services. Internet websites are examples of products and services that are created to give users access to particular types of services, data, or searching capabilities. Online content providers, or publishers, are increasingly moving towards building World Wide Web sites that are more reliant on dynamic, frequently-updated content.

Advertisements are displayed on many websites to generate income. Website publishers are often paid based on the number of clicks an advertisement receives through the publishers website. Thus, it can be beneficial to target advertising toward particular categories of products and/or services that are attractive to the audience of a particular website. Coding individual advertisement for a website can be a time consuming process. Each advertisement may require specification of parameters such as size, placement, along with the product or service category of advertisement to be displayed in the ad space. Additionally, efforts to maximize potential clicks can require a wide variety of ads from a variety of products and services. Another difficulty is found when publishers wish to update the advertisement on a website as each ad may require individual editing.

It is within this context that embodiments of the invention arise.

### SUMMARY OF THE INVENTION

Broadly speaking, the present invention provides website publishers with a tool to efficiently manage sets of reusable advertisement parameters. For example, publishers can create reusable and editable Inventory Identifiers (IIDs) that specify classification attributes within an advertisement inventory. These IIDs can be used throughout a website and even across multiple websites from the same publisher. The IIDs can also promote faster website development and provide efficient management of existing ads because changes to the classification attributes of an IID can be propagated throughout the ads within the website.

In one embodiment, a computer-implemented method having access to memory is disclosed. The method includes operations to select advertising data stored within an inventory unit. In one operation an inventory identifier is defined, the inventory identifier specifying attributes of advertising data within the inventory unit and creating inventory identifier code. In another operation, the inventory identifier is saved to a database. In still another operation upon loading a website, a request is received for the inventory identifier, where the inventory identifier code is integrated within code of the website. The website configured to request advertising data from the inventory unit upon execution of the code that triggers a query to the database to translate the inventory identifier to the specified attributes. In another operation, a match is found among the advertising data within the inventory unit based on the specified attributes. In yet another operation advertising data resulting from the match is sent to a memory associated with a web browser that displays the website on a screen. In another embodiment, a computer-implemented method for fulfilling a request from a web browser is disclosed. The method includes an operation that receives an ad call from a website loaded by the web browser, the website utilizing code associated with an inventory identifier stored within a database. In another operation, the method parses the ad call to enable look-up of the inventory identifier within the database. In yet another operation, the inventory identifier from the database is recalled. The method also includes an operation that extracts data attributes from the recalled inventory identifier, the data attributes defining elements within an inventory unit. In other operations, elements within the inventory unit are accessed based on the extracted data attributes and the accessed inventory elements are sent to a memory accessible by the web browser.

In still another embodiment, a system for defining objects within a database is disclosed. The system includes an inventory identification application that generates an inventory identifier. The inventory identifier being a reference saved to the database that specifies characteristics of data within an inventory unit. A publisher using the inventory identifier application defines the specific characteristics and the inventory identifier application generates code. The publishers use the generated code within a website to recall the inventory identifier that is saved in the database. The system also includes a server system that receives a request to recall the inventory identifier. The request is the result of execution of the generated code when the website is accessed by a user. The request is fulfilled by accessing the inventory identifier at the database and matching data within the inventory unit based on the stored characteristics within the inventory identifier.

### BRIEF DESCRIPTION OF THE DRAWINGS

The invention, together with further advantages thereof, may best be understood by reference to the following description taken in conjunction with the accompanying drawings.

FIG. 1 is an exemplary overview of a system 100 that implements an inventory identifier (inventory ID), in accordance with one embodiment of the present invention.

FIG. 2 is a block diagram representation of how various parties interact with various elements of the system 100, in accordance with one embodiment of the present invention.

FIG. 3A through 3G are exemplary illustration of a graphical user interface used to create an IID, in accordance with one embodiment of the present invention.

FIG. 4 is a flow chart illustrating operations to create an IID, in accordance with one embodiment of the present invention.

FIG. 5 is a flow chart illustrating operations that are performed while loading a website that includes an IID, in accordance with one embodiment of the present invention.

### DETAILED DESCRIPTION

An invention is disclosed for efficiently managing reusable advertisement parameters throughout one or many websites. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

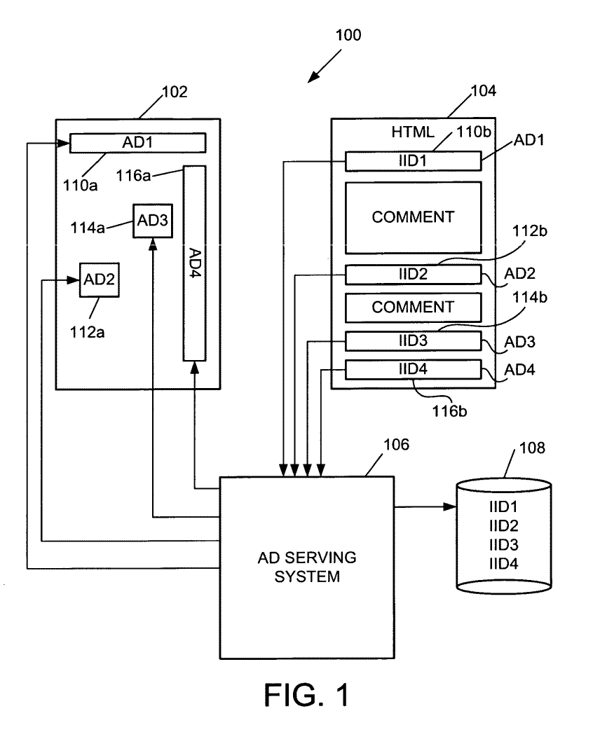

FIG. 1 is an exemplary overview of a system 100 that implements an inventory identifier (inventory ID), in accordance with one embodiment of the present invention. The system 100 includes code 104 that is created by a website publisher and made accessible via a network (not shown) in order render a website 102. The website 102 includes advertisements (ads) 110a, 112a, 114a, and 116a that correspond to Inventory IDs (IIDs) 110b, 112b, 114b, and 116b within the code 104. For simplicity, the code 104 is displayed as simplified boxes representing actual coding. In one embodiment, the coding is HTML code. In other embodiments different coding schemes such as Java or Flash based coding can be used to create code 104. The illustration of website 102 has been simplified to show the placement of ads 110a, 112a, 114a, and 116a within the website 102.

When a browser processes the code 104 for the website 102, the IIDs 110b, 112b, 114b, and 116b generate ad calls that are passed to an ad system 106. The ad system 106 parses the IIDs to generate a call to an IID database 108. The call to the IID database 108 returns to the ad system 106 references to some or all of the classification attributes of a group of inventory units that have been associated with the respective IIDs. System components (not shown) associated with the ad system 106 store and provide access to a wide variety of ads that are selectively accessible via various classifications attributes. In one embodiment the system components include databases, or inventory units, that contain advertisements cross-referenced by classification attributes such as, but not limited to sports, business and finance, and entertainment. The IIDs referenced within the code 104 and stored within the HD database 108 are capable of referring to various classifications attributes or specified attributes in order to specify they types of advertisement that are to be delivered from an inventory unit, or inventory units, to the web browser loading the website.

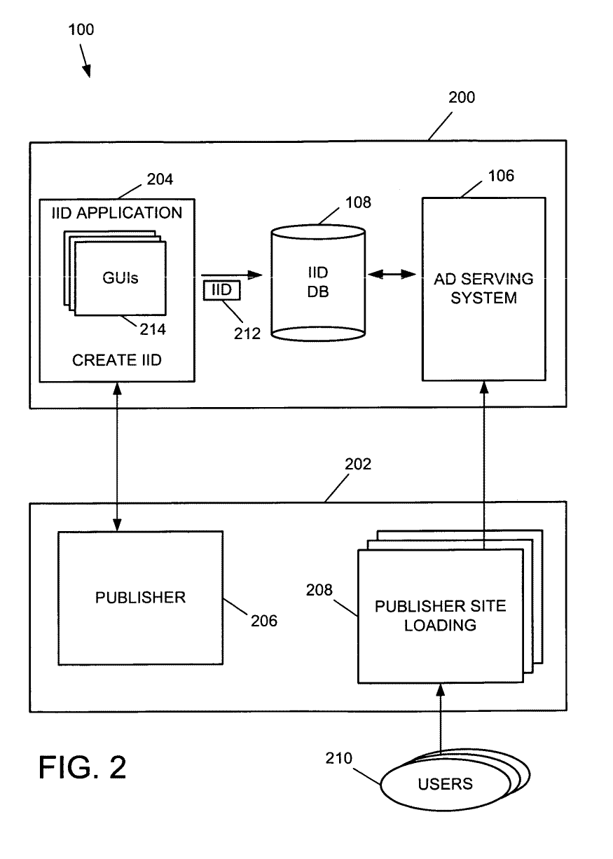

FIG. 2 is a block diagram representation of how various parties interact with various elements of the system 100, in accordance with one embodiment of the present invention. In one embodiment, the system 100 is viewed as an ad-side 200 and a publisher side 202. The ad-side 200 includes the ad system 106, the HD database 106 and an IID application 204. The HD application 204 is used by clients on the publisher side 202 and allows website publishers to simplify and streamline coding of advertisements within their websites. In one embodiment, the IID application 204 is made accessible to clients and website publishers via a web interface. As illustrated in FIG. 2, the publisher 206 on the publisher side 202 accesses the HD application 204 in order to create an HD 212. In this embodiment, the IID application 204 would be stored on a server or multiple servers (not shown) as part of the ad-side 200. In such an embodiment, the publisher 206 uses a Graphical User Interface (GUI) 214 to interact with the HD application 204.

In other embodiments, interaction with the IID application 204 is conducted using command line prompts, textual coding or other programming interfaces. In yet another embodiment, a content management system (not shown) on the publisher side 202 interfaces with the IID application 204 via various web services. The content management system is an automated platform to store content for a publisher and in one embodiment, is capable of automatically generating an IID. Thus, a publisher can configure the content management system to automatically interact with the IID application 204 in order to generate an IID for an advertisement on a website.

When a publisher creates the IID 212 the IID 212 is stored on the IID database 108. On the publisher side 202, the publisher 206 can reference the IID 212 within the code for the published website 208. When the published website 208 is accessed by a user 210, execution of the website code makes an ad call to the ad system 106 on the ad side 200. The ad system 106 is configured to parse the referenced IID within the website code and query the IID database 108 in order to translate the IID to specific attributes, or stored parameters, designating appropriate ads to load. In some embodiments, an ad call has an IID and additional parameters that are explicitly stated within a Uniform Resource Locator (URL). These additional parameters are able to override parameters specified in the IID. The particular embodiments discussed above are intended to be exemplary and should not be considered limiting. For example, in another embodiment, the IID application 204 is stored locally on a publisher side 202 computer (not shown) and has access to data stored on the IID database 108 through a secure internet connection.

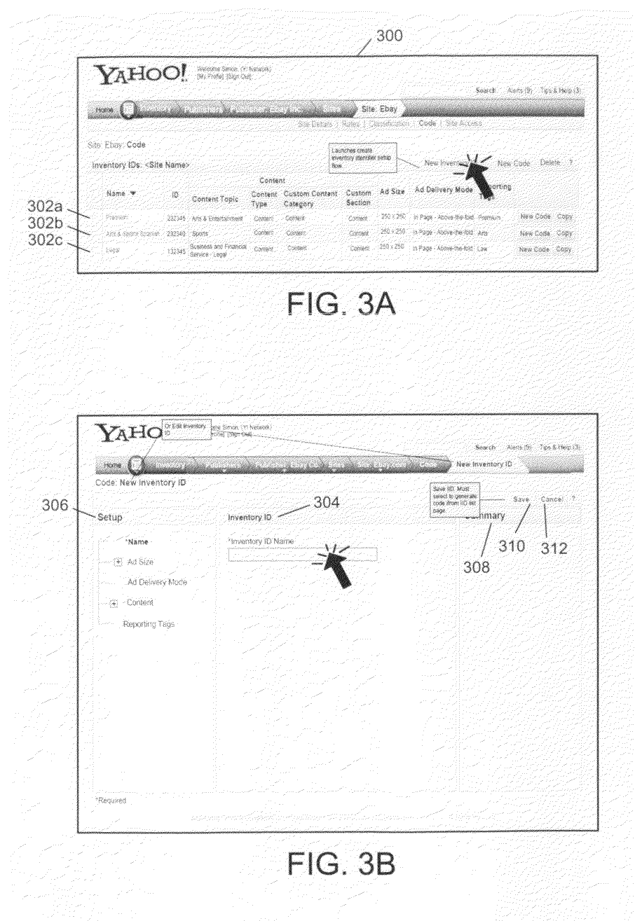

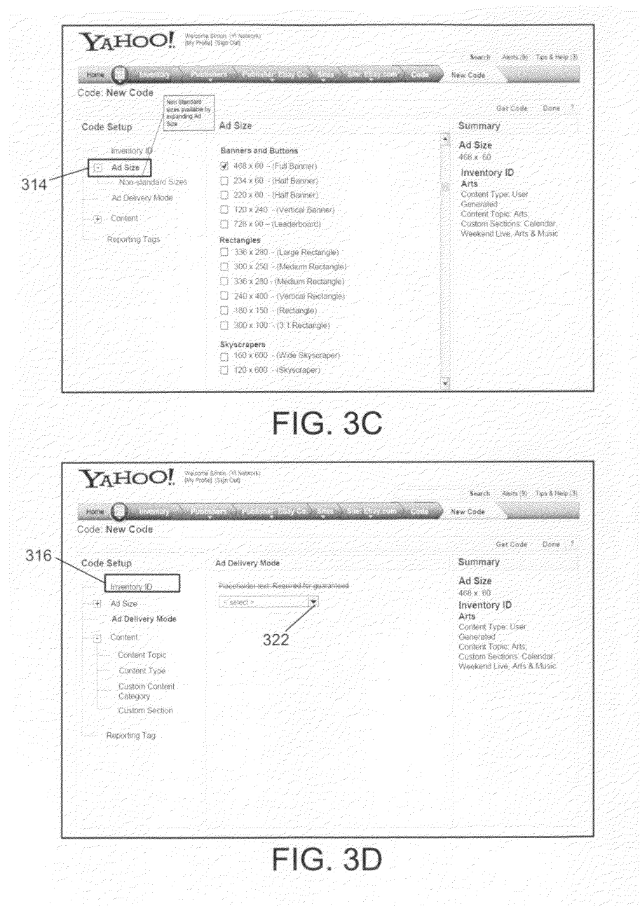

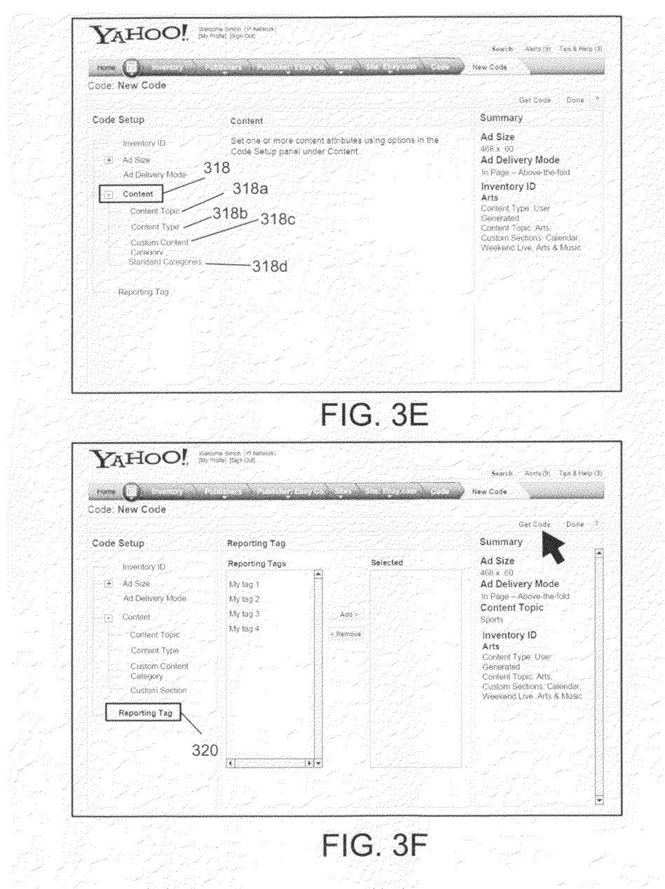

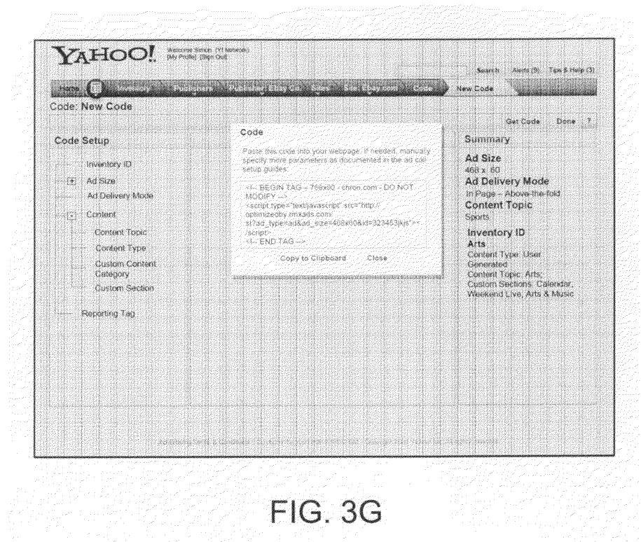

FIG. 3A through 3G are exemplary illustration of a graphical user interface used to create an IID, in accordance with one embodiment of the present invention. FIG. 3A is an intro screen 300 that is displayed when a publisher accesses the IID application. In intro screen 300 is exemplary of one embodiment and various other embodiments allow publishers and users to customize the intro screen 300 based on corporate or personal preferences. In the embodiment shown in FIG. 3A, the intro screen 300 allows a publisher to view and manage existing IIDs 302a, 302b, and 302c. The various fields shown in FIG. 3A should not be considering limiting as individual users are able to customize the displayed fields. The intro screen 300 also allows users to create a new IID by selecting “New Inventory ID” as shown.

FIG. 3B is an exemplary screen illustrating one embodiment of creating a new IID. As illustrated, this embodiment includes headings for setup 306, an inventory ID name 304, a summary 308 along with buttons to save 310 and cancel 312. In one embodiment, the creation of a new IID begins with the publisher specifying an IID name. This allows the publisher to refer to the IID within webpage coding using the publisher specified name or system generated numeric identifier that is automatically created. The use of the publisher specified name allows the publishers to provide meaningful names that are easily identified within the webpage coding. In one embodiment, after entering an IID name, the user must select save 310 before continuing to define additional IID parameters. In another embodiment, after entry of an IID name, a user can begin defining IID parameters by clicking on any of the various categories listed under the setup heading 306.

FIGS. 3C through FIG. 3F illustrate configuring specific attributes of various aspects of a new IID, in accordance with one embodiment of the present invention. FIG. 3C illustrates and exemplary screen to configure an ad size 3 14. In this embodiment, selecting ad size 314 allows a publisher can choose from a variety of pre-determined types of ads, including but not limited to banners and buttons, rectangles, and skyscrapers. As shown, each type of ad can be displayed in a variety of resolutions including standard and non-standard resolutions. FIG. 3D illustrates one embodiment where a publisher defines an ad deliver mode 316. The ad deliver mode can be selected from a pull-down menu 322 and can include ad placement locations such as, but not limited to, in page—above the fold, and in page—below the fold.

FIG. 3E is an exemplary screen illustrating how a publisher can define ad content 318. In one embodiment, to further refine ad content 318, additional sub-categories are included such as content topic 318a, content type 318b, custom content 318c and standard categories 318d. When a user selects content topic 318a, a publisher can select between various topics arranged in categories such as, but not limited to, arts and entertainment, business, classifieds, careers, jobs, lifestyles, news, restaurants/dining, real estate, and shopping. Each of the various categories can be further divided into sub-categories so a publisher can define either a broad or narrow content topic. Furthermore, the publisher can define multiple content topics across a variety of the categories. Based on content topic selections, the publisher can define content type 318b. In one embodiment, the content type 318b that a publisher may choose from include, but are not limited to, user-generated content, pre-defined content, or other content.

Both the custom content 318c and standard categories 318d allow a publisher to further define parameters of the IID. In one embodiment, the publisher can use the custom content 318c and standard categories 318 to specify key advertisement catering to particular key value pairs. Examples of standard categories 318d can include commonly provided data such as an age, gender, and a preferred location or locations. The inclusion of custom content 318c allows publishers to apply custom key-value pairs that are not generally known. The custom content 318c allows publishers to use categories they have independently gathered about their readers or customers. For example, custom content 318c can include categories such as an income range, marital status, or ethnicity. The particular examples described above are intended to be exemplary and should not be construed as limiting. Publishers can use additional key-value pairs within the standard categories 318d and custom content 318d categories.

A publisher may also define a reporting tag 320 during the creation of an IID. The use of reporting tags is voluntary and can be implemented by a publisher. The reporting tags 320 provide a publisher with flexibility in reporting traffic through an advertisement. For example, a reporting tag 320 allows a publisher to create custom reports based on user behavior toward a particular category of advertisements. In another embodiment, reporting tags are created within the IID application in order to manage ad limits for the publisher. For example, the use of reporting tags can allow the ad system to track ad use generated by the IIDs to ensure a publisher does not exceed predetermined ad limits.

FIG. 3G is an exemplary graphical representation of a code generated by the IID application after a publisher defines an IID. The IID application stores the defined IID and the code to the IID server. This allows the publisher to utilize the code within their website or websites in order to instruct a browser to load an ad from the categories referenced within the IID stored on the IID server. In one embodiment, when the code is executed an ad call is generated to the ad system. The ad system parses the code and accesses the IID stored on the IID server to determine the types of advertisements specified by the publisher.

A publisher is able to edit an existing IID stored on the IID server. The ability to edit the IID provides the publisher flexibility and the ability to modify the types of advertisements displayed on multiple websites while simply editing one IID. For example, a publisher can initially create an IID that request an advertisement pertaining to the entertainment industry, particularly movies. The publisher can use the IID referring to movies throughout a website or even websites. Without the use of IIDs, the publisher would need to write HTML code for each movie advertisement. At a later date, the publisher would prefer the movie advertisements be related to the music aspect of the entertainment industry. With IIDs, instead of having to individually edit HTML code to reference a new music advertisement for each advertisement, one change to the IID using the IID application can update every ad that utilizes the code initially generated by the IID.

Though described above as including all of the sub-categories such as content topic 318a, content type 318b, custom content 318c and standard categories 318d, publishers are able to create IIDs by defining as many or as few parameters as they wish. Extensively defining attributes or parameters can result in the published website retrieving ads from a narrow, well-defined categories. Conversely, defining fewer attributes can result in the published website displaying a wide variety of ads.

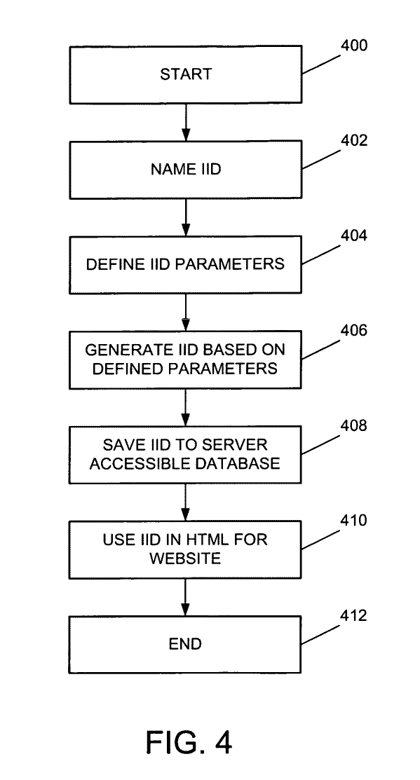

FIG. 4 is a flow chart illustrating operations to create an IID, in accordance with one embodiment of the present invention. The creation of an IID begins with START operation 400. Operation 402 allows the publisher to specify an identifier name while operation 404 is where the publisher defines IID parameters. As previously discussed, publishers can define IIDs using various parameters such as ad size, ad delivery, reporting and various content parameters. In different embodiments, the various content parameters include parameters such content topic, content type, custom content and standard categories.

Operation 406 generates an IID from the parameters defined by the publisher in operation 404. The generated IID is a reusable object that references some or all of the publisher defined parameters for an online advertisement. The reusable nature of the IID allows the publisher to streamline website design and development as IIDs can be copied and pasted into various portions of a website. Additionally, modifying the IID using the IID application allows changes in the IID to be propagated without having to replace code in each individual website referencing the IID. In another operation, operation 408, the IID is saved to a database that is accessible by the ad system such as, but not limited to the IID database. With Operation 410 a publisher uses an IID within website code to reference the predefined parameters within the IID that designate a classification of attributes within an inventory of advertisement. The creation of an inventory ID is completed with END operation 412.

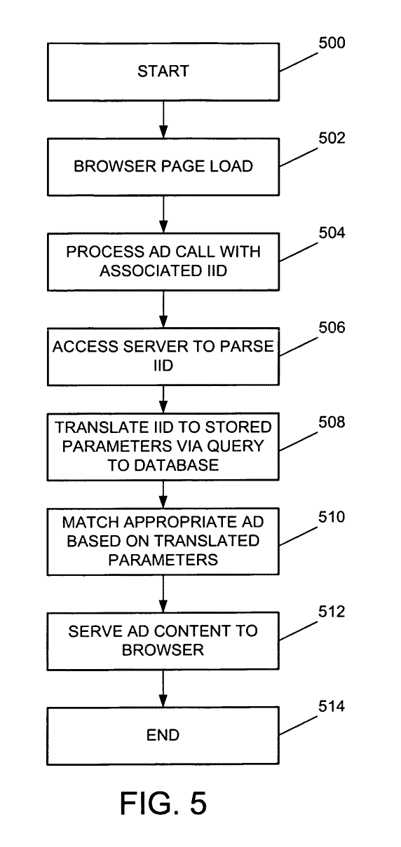

FIG. 5 is a flow chart illustrating operations that are performed while loading a website that includes an IID, in accordance with one embodiment of the present invention. START operation 500 beings the procedure while a web browsers begins loading the website with operation 502. As the web browser processes the code of the website, an ad call with an associated IID is made to the ad system via an active internet connection. In operation 504, the ad system processes the ad call to extract the associated IID. The procedure also includes operation 506 that parses the extracted IID. Operation 508 translates the parsed IID to the stored parameters via a query to the IID database. With operation 510, an appropriate ad is matched to the IID based on the stored parameters and operation 512 provides the appropriate ad to the browser.

With the above embodiments in mind, it should be understood that the invention may employ various computer-implemented operations involving data stored in computer systems. These operations include operations requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The above-described invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a communications network.

The invention can also be embodied as computer readable code on a computer readable medium. The computer readable medium is any data storage device that can store data that can be thereafter read by a computer system, including an electromagnetic wave carrier. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A computer-implemented method having access to memory, the method selecting advertising data stored within an inventory unit, comprising:
(a) defining an inventory identifier, the inventory identifier specifying attributes of advertising data within the inventory unit and creating inventory identifier code;
(b) saving the inventory identifier to a database;
(c) receiving a request for the inventory identifier from a website upon loading, the inventory identifier code being integrated within code of the website, the website configured to request advertising data from the inventory unit upon execution of the code that triggers a query to the database to translate the inventory identifier to the specified attributes;
(d) matching the advertising data within the inventory unit based on the specified attributes; and
(e) sending advertising data resulting from the match to a memory associated with a web browser that displays the website on a screen.

2. The method of claim 1, wherein the inventory identifier code is compact, reusable code that points to the inventory identifier saved to the database.

3. The method of claim 1, wherein the inventory identifier is defined using an inventory identifier application.

4. The method of claim 1, wherein the code is executed as the website is loaded by a web browser.

5. The method of claim 1, wherein the inventory identification is included within ad call code.

6. The method of claim 5, wherein the ad call specifies additional data attributes, and the additional data attributes of the ad call supersedes data attributes of the inventory identification.

7. The method of claim 1, further comprising:
changing the specified data attributes to create a modified inventory identifier.

8. The method of claim 7, wherein executing the code results in matching data within the inventory unit based on the data attributes of the modified inventory identifier.

9. A computer-implemented method having access to memory, the method fulfilling a request from a web browser, comprising:
(a) receiving an ad call, the ad call originating from a website loaded by the web browser, the website utilizing code associated with an inventory identifier, the inventory identifier stored within a database;
(b) parsing the ad call to enable look-up of the inventory identifier within the database;
(c) recalling the inventory identifier from the database;
(d) extracting advertising data attributes from the recalled inventory identifier, the advertising data attributes defining types of advertisements within an inventory unit;
(e) accessing advertisement within the inventory unit based on the extracted advertising data attributes; and
(f) sending the accessed advertisement to memory accessible by the web browser.

10. The method of claim 9, wherein the ad call specifies additional data attributes and the additional data attributes of the ad call supersedes data attributes of the inventory identification.

11. The method of claim 9, wherein an inventory identifier application is used to define the advertising data attributes of the inventory identifier.

12. The method of claim 11, wherein the inventory identifier application permits modification of the advertising data attributes of existing inventory identifiers.

13. The method of claim 12, wherein code associated with an existing inventory identifier remains unchanged after modification of an existing inventory identifier.

14. A system for defining objects within a database, comprising:
an inventory identification application that generates an inventory identifier, the inventory identifier being a reference saved to the database, the inventory identifier specifying characteristics of advertisement data within an inventory unit defined by a publisher using the inventory identifier application, the inventory identifier application generating code that publishers use within a website to recall the inventory identifier that is saved in the database;
a server system that receives a request to recall the inventory identifier, the request resulting from execution of the generated code when the website is accessed by a user, the request being fulfilled by accessing the inventory identifier at the database and matching advertisement data within the inventory unit based on the stored characteristics within the inventory identifier.

15. The system of claim 14, wherein the inventory identifier is part of ad call code.

16. The system of claim 15, wherein the ad call code specifies additional advertisement data attributes and the additional advertisement data attributes of the ad call supersedes advertisement data attributes of the inventory identification.

17. The system of claim 14, wherein the code generated by the inventory identifier application is associated with the inventory identifier.

18. The system of claim 17, wherein the inventory identifier application allows the publisher to edit the specifying characteristics of an existing inventory identifier.

19. The system of claim 18, wherein the code associated with the inventory identifier remains unchanged after modification of an existing inventory identifier.
